(19) United States
(12) Patent Application Publication
(10) Pub. No.: US 2005/0273372 A1
(43) Pub. Date: Dec. 8, 2005

(54) INTEGRATED SYSTEM FOR SCHEDULING MEETINGS AND RESOURCES

(75) Inventors: James Pennell Bowne, Poughkeepsie, NY (US); Christopher Edward Obszarny, Poughkeepsie, NY (US)

Correspondence Address: INTERNATIONAL BUSINESS MACHINES CORPORATION;DEPT. 18G, BLDG. 300-482, 2070 ROUTE 52, HOPEWELL JUNCTION, NY, 12533, US

(73) Assignee: INTERNATIONAL BUSINESS MACHINES CORPORATION, Armonk, NY (US)

(21) Appl. No.: 10/709,884

(22) Filed: Jun. 3, 2004

(51) Int. Cl. G06F 17/60

(52) U.S. Cl. 705/5

(57) ABSTRACT

An automated system and method for organizing and scheduling meetings is described whereby, under a single integrated interface, a meeting organizer can identify a list of invitees from an address book database, select a meeting location from a hierarchical locations database, and identify meeting resources from a hierarchical resource database. Candidate meeting locations can be organized hierarchically by location (e.g., state, town, building, room) or by organization (company, division, campus, building, etc.) and can be selected by searching the locations database for meeting locations that satisfy search criteria based upon address book information (e.g., location) associated with the list of invitees. Resources can be similarly identified by searching the resource database for requested resources that satisfy search criteria based upon the selected meeting location (e.g., requested resources that are available at that location). Schedule management, meeting location reservations, and resource management are all integrated. Meeting times can be determined by selecting times when the invitees, meeting location and requested resources are all simultaneously available.

### BACKGROUND OF INVENTION

The present invention relates to automated systems for coordinating schedules and activities; and more particularly to scheduling of meetings with such systems.

The rapid growth of networked communications over the last decade, particularly Internet communications, has produced numerous new methods of business communications, e.g. between members of a workgroup. Many activities that were once performed manually can now be automated via computer communications. For example, meeting scheduling typically involves setting up a meeting, identifying the attendees, sending out meeting notices, keeping track of acknowledgements, reserving a conference room, reserving any special facilities (e.g., presentation materials, audio-visual equipment, etc.), sending out reminders, handling schedule and resource conflicts, etc. Until recently, for any given meeting, one or more individuals would typically perform such meeting-related scheduling and coordination manually. This manual scheduling and coordination often requires considerable time and effort. With the advent of widespread computer communications and the widespread availability of e-mail, some software-based systems have been created to facilitate and/or automate much of the drudgery and detail management associated with meeting scheduling.

“Collaboration” software systems such as Lotus Notes produced by IBM Corporation, attempt to coordinate many of the activities between individuals in an organization. Such software typically includes a hierarchical database of contacts and co-workers catalogued by location, project assignments, etc., and a calendar/schedule management facility for scheduling and keeping track of appointments, meetings, activities, deliverables, etc. These systems often include a meeting coordination (sub)system for organizing and scheduling meetings. Such meeting features typically permit a meeting organizer (typically the meeting chairperson or his delegate) to locate and identify attendees based upon their project affiliations, physical location, etc. Once a list of attendees has been identified, the collaboration software typically provides a mechanism whereby all of the various attendees' schedules can be coordinated to identify a time when all attendees will be available. The meeting organizer then locates and reserves a suitable meeting location, requests and reserves any required resources (e.g., presentation aids, catering service, etc.). Upon successfully obtaining a meeting location and resources, the meeting organizer confirms the meeting time and identifies the meeting location to the collaboration system and automatically sends out meeting notices to the attendees. Attendees with e-mail addresses are notified by the collaboration system via e-mail. Other attendees can be notified by inter-office memorandum, by mail, or by any other suitable mechanism. Collaboration systems often have features that facilitate sending these other forms of meeting notice (e.g., automatic or semiautomatic letter/.memo composition and printing, addressing, envelope printing, etc.).

As used herein, the term “collaboration system” refers to any system for automated coordination and scheduling one or more activities for multiple individuals. Typically, such systems employ client software running on computers assigned to some or all of the individuals, each client having access to a common database. The database can be either centrally located on a main server or distributed across multiple computers.

FIG. 1 is a block diagram of a meeting coordination system 100 of a typical prior-art collaboration system. A meeting coordination form (or group of forms) is presented to the system user (in this case, the meeting organizer) via a form GUI 102 (Graphical User Interface). Such a GUI typically comprises a graphical or textual form layout, data objects to be represented on the form and form control software for controlling the behavior of the form and display of its associated data objects. In the present context, even a purely text-based command-line interface could be employed. A “chair” data object 104 identifies a meeting chairperson. An “invitees” data object 106 identifies the list of individuals who will be requested to attend the meeting. A “location” data object 108 identifies the location (meeting place, e.g., conference room) where the meeting will be held. An address book 110, typically organized as a hierarchical database (HDB), provides a mechanism by which the meeting organizer can quickly locate and identify the invitees to the meeting. (The chairperson will typically also be included in this database). The hierarchical organization of the address book allows individuals listed therein to be grouped according to one or more multi-level hierarchical indexing schemes. An example of such a hierarchy would be an organization of individuals by company, division, department, workgroup, job function and project assignment. Another example of a useful multi-level hierarchy would be organization by work location, e.g., company, country, region or city, campus and building. Any single or multi-level indexing scheme can be accommodated in this way.

Each database entry for each individual contains a variety of relevant information such as, location, mailing address, e-mail address, telephone number, link to manager's database entry, link to the individual's calendar/schedule information, etc. A calendar/schedule manager facility 112 provides a mechanism whereby each individual's schedule and appointments are maintained by the collaboration system. By comparing schedules of meeting invitees, the meeting coordination system 100 can identify times when all of the invitees (and the chair) are available. Within the meeting form GUI 102, the meeting organizer can utilize the address book 110 to identify individual meeting invitees and add them to the invitees data object 106. The meeting chair data object 104 is populated in similar fashion. If the meeting organizer is the meeting chairperson, then the user's identity can be used to populate the chair data object 104 automatically by default.

Upon completing the list of invitees and settling on a suitable meeting time, the meeting organizer then secures a suitable meeting location and any other required resources, then fills in the location data item. This information is then used to automatically generate and send out meeting notices.

Although the system described above represents a significant improvement over non-automated methods for organizing meetings, considerable time and effort may still be required of the meeting organizer(s) in locating and reserving meeting rooms and meeting resources. One particularly difficult situation occurs when a meeting is “bumped” from its location by a higher-priority meeting. If the meeting organizer becomes aware of the loss of a meeting location early enough, a new meeting room can be reserved, schedules can be changed and notices can be sent out. However, as is often the case, the meeting organizer may not become aware of the loss of the meeting location until the day of the meeting. If a new meeting room cannot be located very quickly, many of the invitees may have traveled to the originally scheduled meeting location only to be turned away at the last minute and told that the meeting will be rescheduled at a later date. This can be quite time consuming and costly.

### SUMMARY OF INVENTION

The present inventive technique overcomes the problems cited above by integrating a meeting location database and reservation facility into a meeting coordination subsystem of the collaboration system. A locations database essentially an “address book” of meeting locations is maintained in a hierarchical database similar to that employed to maintain an address book of individuals. Meeting rooms in the database can be organized and indexed according to one or more hierarchical indexing schemes to facilitate their location by meeting organizers. Each meeting room has a schedule calendar similar to the individuals' calendars by which meeting rooms can be reserved and coordinated with invitees' schedules. Using these capabilities (location database and scheduling facility), a meeting organizer can quickly locate and a suitable meeting room that is available at a time when all of the invitees are available.

According to an aspect of the present inventive technique, a resource database can also be maintained and associated with locations and/or meeting rooms. A scheduling and reservation facility is provided for the resources so that they can be coordinated with other aspects of the meeting. For example, a particular meeting might require a meeting room with a particular number of chairs, an extra presentation table, a video projector and projection screen. Further, the meeting organizer might wish to provide beverage/snack service and lunch service for the meeting. All of these resources can be located and reserved in much the same fashion as invitees and meeting rooms are coordinated.

According to one aspect of the invention, the resource database and locations database can be integrated into a single unified resources database.

According to another aspect of the invention, the resource database, locations database and address book databases can all be integrated into a single unified database and managed and searched via a single common database engine.

According to another aspect of the invention, one or more candidate meeting locations can be determined by searching the locations database (or locations database portion of a unified database) for meeting locations that meet predetermined selection criteria bases upon address book information associated with a list of identified meeting invitees.

According to another aspect of the invention, requested meeting resources can be identified by searching the resource database (or resource database portion of a unified database) for resources that meet predetermined selection criteria based upon database information associated with the selected meeting location.

### BRIEF DESCRIPTION OF DRAWINGS

These and further features of the present invention will be apparent with reference to the following description and drawing, wherein:

FIG. 1 is block diagram of a meeting coordination portion of a collaboration system, according to the prior art.

FIG. 2 is a block diagram of an embodiment of a meeting coordination portion of a collaboration system with integrated location management capability, in accordance with the present invention.

FIG. 3 is a block diagram of an embodiment of a meeting coordination portion of a collaboration system with integrated location and resource management capabilities, in accordance with the invention.

FIG. 4 is a block diagram of an embodiment of a meeting coordination portion of a collaboration system with integrated location and resource management capabilities and fully-integrated database and scheduling facilities, in accordance with the invention.

### DETAILED DESCRIPTION

The present inventive technique extends and improves prior-art meeting coordination systems of collaboration systems by providing interactive location and resource management capability. By making the observation that locations and/or resources can be maintained in “address books” similar to those used to maintain address books of individuals, location of suitable meeting rooms and resources can be integrated into the meeting coordination function. Further, it is observed that the process of scheduling and maintaining meeting room reservations and resource reservations is virtually identical in principle to the process of scheduling and maintaining individuals' appointment schedules, so similar or identical techniques can be used to integrate location and resource management into the meeting coordination function.

According to the present inventive technique, each meeting room and resource has a schedule calendar similar to the individuals' calendars by which meeting rooms and resources can be reserved and coordinated with meeting invitees' schedules. Using these capabilities, a meeting organizer can quickly locate and reserve a suitable meeting room that is available at a time when all of the invitees are available and arrange for meal/snack service, extra chairs and tables, easels, notepads, pens/pencils, presentation facilities, videoconferencing, etc., all from within the same integrated meeting coordination system of the collaboration system.

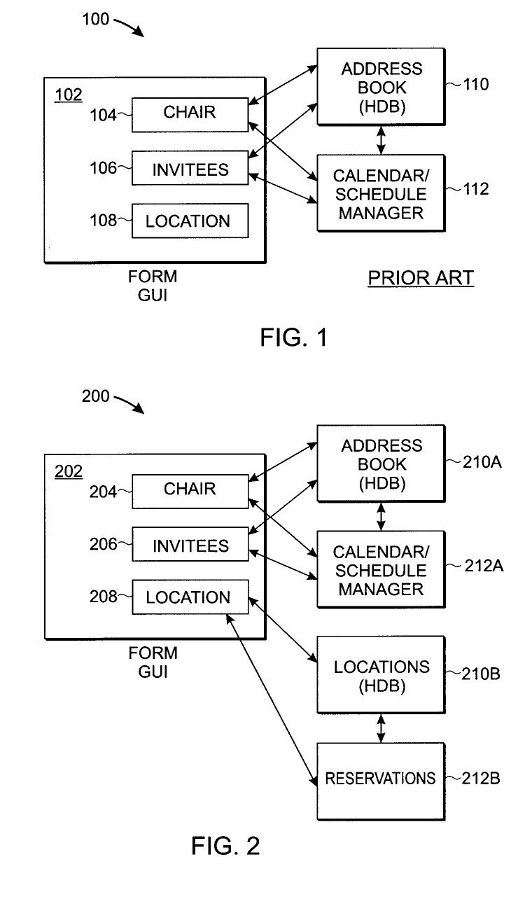

FIG. 2 is a block diagram of an embodiment of a meeting coordination system 200 of a collaboration system with integrated location management capability, in accordance with the present invention. Similar to the prior-art meeting coordination system 100 of FIG. 1, a meeting coordination form (or group of forms) is presented to the meeting organizer via a form GUI 202. In the present inventive context, a form GUI can implement a fully graphical interface, a textual form-based interface, or a text-based command line interface may be substituted and will be considered equivalent. Generally speaking, graphical and form-based interfaces are “friendlier” and easier to use, and are preferred, but any suitable means of interfacing with a meeting organizer may be employed. As in FIG. 1, a “chair” data object 204 identifies a meeting chairperson, an “invitees” data object 206 identifies a list of individuals who will be requested to attend the meeting and a “location” data object 208 identifies the location where the meeting will be held. An address book 210A allows the meeting organizer to locate and identify the invitees to the meeting. As shown and described hereinabove with respect to FIG. 1, the address book 210A organized hierarchically to permit individuals listed therein to be grouped according to one or more convenient multi-level hierarchical indexing schemes.

Each database (address book) entry for each individual contains a variety of relevant information such as, location, mailing address, e-mail address, telephone number, link to manager's database entry, link to the individual's calendar/schedule information, etc. A calendar/schedule manager facility 212A permits each individual's schedule and appointments to be maintained by the collaboration system. Within the meeting form GUI 202, the meeting organizer can utilize the address book 210A to identify individual meeting invitees and add them to the invitees data object 206. The meeting chair data object 204 is populated in similar fashion. As before, if the meeting organizer is the meeting chairperson, then the user's identity can be used to populate the chair data object 204 automatically by default. By comparing schedules of meeting invitees and the chair, the meeting coordination system 200 can identify times when all of the invitees and the chair are available and suggest one or more suitable meeting times accordingly.

In addition, the meeting coordination system 200 includes a locations database 210B and a reservations function 212B. The locations database 210B is essentially an address book for meeting locations and can be organized in much the same way as the address book 210A. Optionally, the same database system can be used to maintain both the locations database 210B and the address book 210A. The reservations function 212B is essentially a calendar/schedule manager for locations, and operates in similar or identical fashion to the calendar/schedule manager 212A, differing primarily in that it operates on the schedules of locations rather than individuals. Optionally, the same schedule management facilities of the collaboration system can be used to implement both the calendar/schedule manager 212A and the reservations function 212B.

In the same way as the form GUI 102 of FIG. 1 coordinates between individual's schedules, the form GUI 202 of FIG. 2 is adapted to further coordinate the schedule associated with the location indicated by the location data object 208 with the schedules of the invitees indicated by the invitees data object 206 and the schedule of the chairperson indicated by the chair data object 204 to determine a suitable meeting time and location when all attendees (invitees and chair) and the meeting location are simultaneously available.

Preferably, the reservations function 212B provides a “bump” function whereby if a location (e.g., conference room) is taken over by another higher-priority meeting, a message is sent to the meeting organizer indicating the loss of the meeting location. In many cases, this will provide the meeting organizer with early notification of the change so that an alternative location and resources can be reserved and notifications can be sent out to the invitees informing them of the change.

Further, it is preferable that the reservations function 212B provide an “on-call” function, whereby if a meeting room (or group of rooms) is unavailable at a desired time, the meeting organizer can opt to be placed on a reservation “waiting list” for the room (or any of a group of rooms). If a prior reservation for a room is cancelled, then if there is a waiting list for the room, the reservation function can notify the next in line for the room that it has become available, and make a tentative reservation for the room subject to the meeting organizer's approval.

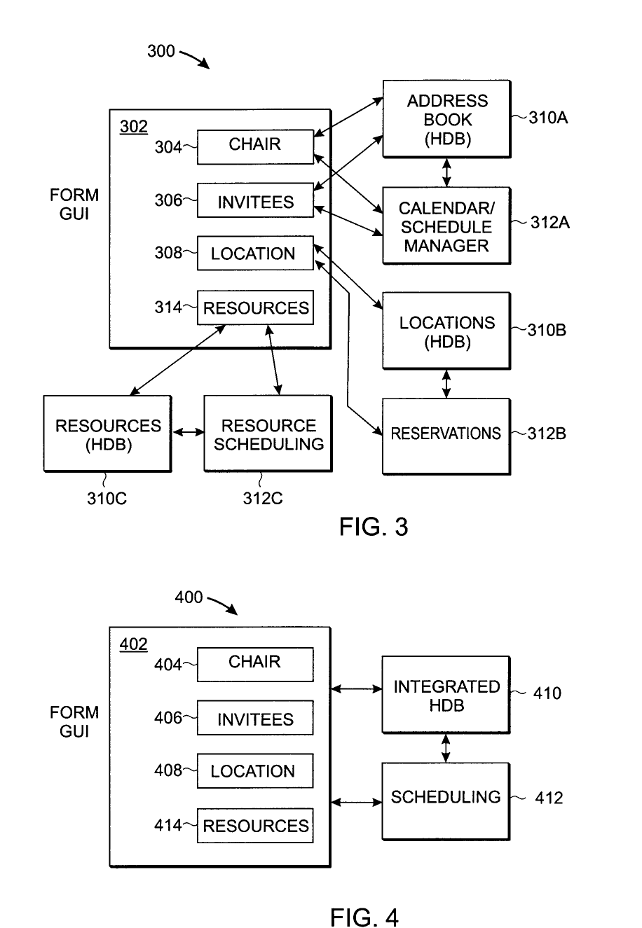

FIG. 3 is a block diagram of another embodiment of a meeting coordination system 300 of a collaboration system similar to the meeting coordination system 200 of FIG. 2, but adding integrated resource management capability. As in FIG. 2, the meeting coordination system 300 of FIG. 3 includes a meeting coordination form (or group of forms), presented to the meeting organizer via a form GUI 302. A “chair” data object 304 identifies a meeting chairperson, an “invitees” data object 306 identifies a list of individuals who will be requested to attend the meeting and a “location” data object 308 identifies the location where the meeting will be held. An address book 310A allows the meeting organizer to locate and identify the invitees to the meeting. A calendar/schedule manager facility 312A manages and maintains each individual's schedule and appointments within the collaboration system. Within the meeting form GUI 302, the meeting organizer can utilize the address book 310A to identify individual meeting invitees and add them to the invitees data object 306. The meeting chair data object 304 is populated in similar fashion. As before, if the meeting organizer is the meeting chairperson, then the user's identity can be used to populate the chair data object 304 automatically by default. A locations database 310B and a reservations function 312B (compare 210B, 212B) provide for rapid selection and scheduling of a meeting location.

The form GUI 302 also includes a “resources” data object 314 for identifying resources that will be required for the meeting. Such resources can include chairs, tables, presentation materials, videoconferencing facilities, projector/screen, writing materials, catering services etc. A resources database 310C acts as an “address book” for resources, and a resource scheduling function 312C facilitates resource schedules and reservations. Like the locations database 310B, the resource database 310C can be implemented in essentially the same way as the address book 310A, substituting resources for individuals. Optionally, the same database management functions of the collaboration system can be employed to implement the address book 310A, locations database 310B and resources database 310C. Similarly, the resource scheduling function 312C is similar or identical to the calendar/schedule manager 312A and reservations function 312B. Optionally, the same calendar and schedule management functions of the collaboration system can be used to implement the calendar/schedule manager 312A, the reservations function 312B and the resource scheduling function 312C.

The locations database 312B and resources database 312C can include contact information with links to individuals responsible for preparing the locations and/.or for providing the resources. In making reservations, the meeting coordination system 300 can use these links to generate automatic notifications to those individuals of the newly made reservations in much the same manner as meeting invitations are sent out to invitees. Since resources are occasionally “bumped” in much the same way as locations, the resource scheduling function 312C can include “bump notification” whereby a message is sent to the meeting organizer, giving early notification of the loss of a requested resource. In this way the meeting organizer is given as much time as possible to make alternate arrangements and send out notifications, if necessary.

By having the additional capability of resource management, the form GUI 302 can be adapted to coordinate the schedules of the chair, the invitees, the meeting location and the resources to identify a suitable time when all are simultaneously available. This capability greatly reduces the amount of time and effort required of the meeting organizer to put together a meeting, location and resources, and greatly reduces the likelihood of human error in the process.

Address information associated with the locations database 310B and address information associated with invitees' address book entries can be used to provide directions to the meeting location, personalized for each invitee. This can be accomplished through the use of conventional mapping/route-finding software. By providing the invitee's location and the meeting location to the mapping/route-finding software, a suitable route can be determined, and maps and directions can be automatically generated and appended to an invitation message sent to each invitee.

As described hereinabove, the address book (210A, 310A), locations database (210B, 310B) and resources database (310C) are all similarly organized and can be managed by the same database management functions of the collaboration software. Similarly, the calendar/schedule manager (212A, 312A), reservations function (212B, 312B) and resource scheduling function (312C) are all similarly organized and can be managed by the same calendar/scheduling functions of the collaboration software. This suggests the use of a fully integrated database and scheduling system whereby individuals, locations and resources are all organized and managed under a single database, and a fully integrated calendar/scheduling system whereby individuals' schedules, location reservations and resource scheduling/reservations are all managed under a single calendar/schedule management system.

This is illustrated in FIG. 4, which is a block diagram of a meeting coordination system 400 of a collaboration system with a fully-integrated and cross-linked hierarchical database (HDB) 410 for individuals, locations and resources and a fully-integrated scheduling function 312B for managing and coordinating individuals' schedules and appointments, location reservations and resource reservations. A form GUI 402 includes a chair data object 404, an invitees data object 406, a locations data object 408 and a resources data object 414 similar to those described hereinabove with respect to FIG. 3. The primary difference is the integration of the database and scheduling functions. This integration reduces duplications and improves internal consistency, potentially providing for greater efficiency.

One advantageous feature of the present inventive technique is that it facilitates automated selection of a meeting location based upon the list of invitees, selection of resources based upon the meeting location, etc. As an example, if the address book database entries for a list of invitees indicate that they are geographically diverse, the form GUI can automatically select a meeting location or provide a list of candidate locations according to criteria specified by the meeting organizer. A “centrally located” criterion could be used to search the locations database for available meeting locations as close as possible to the geographic center of the locations of the list of invitees. A “center of gravity” criterion could be used to sear the locations database in similar fashion for meeting locations nearest a weighted geographic center of the locations of the list of invitees. A “largest number of invitees” criterion could be used to identify meeting locations closest to the largest number of invitees. Alternatively, meeting locations nearest a key invitee (e.g., an important person or someone around whose schedule the meeting must be organized) could be identified. This is accomplished by performing a directed search of the locations database according to location information gleaned from the address book entries associated with the list of meeting invitees.

Another approach to scheduling meetings between geographically diverse participants facilitated by the present inventive technique is to request and reserve multiple meeting rooms, with videoconferencing facilities (or similar teleconferencing resources) being used to “link” the locations together.

By way of further example, once a meeting location (or locations) has been specified, resources can be identified based upon the meeting location(s). Typically, certain types of resources are associated with locations. The availability of chairs, tables, projectors, audio-visual facilities, videoconferencing capability, etc., are usually directly associated with a particular meeting location of closely related group of locations (e.g., a group of meeting rooms within a specific building or conference center). Specific catering services (beverages, meals, snacks, etc.) are usually limited to specific geographical regions. The form GUI can permit the meeting organizer to specify “beverage service” in a generic fashion, searching the resources database to identify a specific beverage service provider capable of serving the specific meeting location. Similarly, the form GUI can respond to a generic request for chairs and tables by searching the resources database to identify resource providers capable of providing the request resources at the selected meeting location(s).

Those of ordinary skill in the art will immediately understand there are many possible variations on the inventive technique adding location and resource management capability to the meeting coordination systems of collaboration systems. For example, locations and resources could be merged and handled under an omnibus “Resources” heading. Alternatively or additionally, the database functions and scheduling functions could be extended to link up with external address books on other systems or to connect with an external conference room or resource scheduling system for specific rooms or resources. Such adaptations are fully within the spirit and scope of the present invention.

Although the invention has been shown and described with respect to a certain preferred embodiment or embodiments, certain equivalent alterations and modifications will occur to others skilled in the art upon the reading and understanding of this specification and the annexed drawings. In particular regard to the various functions performed by the above described inventive components (servers, clients, reservations systems, schedule managers, etc.) the terms (including a reference to a “means”) used to describe such components are intended to correspond, unless otherwise indicated, to any component which performs the specified function of the described component (i.e., that is functionally equivalent), even though not structurally equivalent to the disclosed structure which performs the function in the herein illustrated exemplary embodiments of the invention. In addition, while a particular feature of the invention may have been disclosed with respect to only one of several embodiments, such feature may be combined with one or more features of the other embodiments as may be desired and advantageous for any given or particular application.

1. An automated system for scheduling and organizing meetings, comprising:
a form GUI for interfacing with a user, said form GUI including an invitees data object for identifying meeting one or more invitees, and
a location data object for identifying a meeting location;
an address book database responsive to said form GUI for locating individuals to identify as invitees;
a locations database responsive to said form GUI for locating a meeting location;
a calendar/schedule manager responsive to said form GUI for coordinating invitees' schedules; and
a reservation function responsive to said form GUI for scheduling and reserving a meeting location.

2. The system according to claim 1, wherein said form GUI is operative to coordinate the calendar/scheduler manager to identify one or more meeting times when all invitees indicated by the invitees data object are available.

3. The system according to claim 2, wherein said form GUI is further operative to coordinate the reservation system with the calendar/schedule manager to identify one or more meeting times when all of the invitees and a meeting location indicated by the location data object are simultaneously available.

4. The system according to claim 1, further comprising:
a resources database responsive to said form GUI for identifying one or meeting resources; and
a resource manager responsive to said form GUI for scheduling and reserving meeting resources,
wherein said form GUI further includes a resources data object to identify one or more meeting resources.

5. The system according to claim 4, wherein said form GUI is operative to coordinate the calendar/schedule manager, reservation function and resource manager to identify one or more meeting times when all invitees indicated by the invitees data object, a location indicated by the location data object and any resources indicated by the resource data object are all simultaneously available.

6. The system according to claim 4 wherein:
said locations database and said resources database are combined into a single integrated resources database; and
said reservation function and resource manager are combined into a single integrated calendar/schedule manager function.

7. The system according to claim 4 wherein:
said address book database, said locations database and said resources database are combined into a single integrated database; and
said calendar/schedule manager, said reservation function and said resource manager are combined into a single integrated calendar/schedule manager function.

8. The system according to claim 4, wherein:
said resource manager is adapted to send a notification to a meeting organizer in the event that a reserved resource becomes unavailable.

9. The system according to claim 1, wherein said reservation function is adapted to send a notification to a meeting organizer in the event that a reserved meeting location becomes unavailable.

10. The system according to claim 1, wherein said form GUI further comprises a chair data object for indicating a meeting chairperson.

11. A method for automated meeting coordination, comprising the steps of:
providing a form GUI for interfacing with a user;
providing an address book database responsive to said form GUI for locating individuals to identify as invitees;
providing a locations database responsive to said form GUI for locating a meeting location;
providing a calendar/schedule manager responsive to said form GUI for coordinating invitees' schedules;
providing a reservation function responsive to said form GUI for scheduling and reserving a meeting location;
identifying a set of meeting invitees by means of said address book database;
identifying a meeting location by means of said locations database; and
selecting a meeting time when the invitees and the meeting location are all available by means of said calendar/schedule manager and said reservation function.

12. The method according to claim 11, further comprising the steps of:
providing a resources database responsive to said form GUI for identifying one or meeting resources;
providing a resource manager responsive to said form GUI for scheduling and reserving meeting resources;
identifying one or more meeting resources; and
selecting a meeting time when the invitees, the meeting location and the meeting resources are all available by means of said calendar/schedule manager, said reservation function and said resource manager.

13. The method according to claim 12 including the steps of:
providing said locations database and said resources database as a single integrated resources database; and
providing said reservation function and resource manager as a single integrated calendar/schedule manager function.

14. The method according to claim 12 including the steps of:
providing said address book database, said locations database and said resources database as a single integrated database; and
providing said calendar/schedule manager, said reservation function and said resource manager as a single integrated calendar/schedule manager function.

15. The method according to claim 12, further comprising the step of sending a notification to a meeting organizer in the event that a reserved resource becomes unavailable.

16. The method according to claim 11, further comprising the step of sending a notification to a meeting organizer in the event that a reserved meeting location becomes unavailable.

17. The method according to claim 11, further comprising the step of identifying a meeting chairperson by means of said address book database.

18. The method according to claim 11, further comprising the step of identifying a meeting organizer individual as a meeting chairperson.

19. A system for scheduling and organizing meetings on a collaboration system, comprising the steps of:
providing a user interface for communicating with a meeting organizer user;
providing an address book database responsive to said user interface for identifying meeting invitees;
providing a locations database responsive to said user interface for identifying meeting locations;
providing a resources database responsive to said user interface for identifying one or meeting resources;
providing a calendar/schedule manager responsive to said user interface for coordinating invitees' schedules;
providing a reservation function responsive to said user interface for scheduling and reserving a meeting location;
providing a resource manager responsive to said user interface for scheduling and reserving meeting resources;
identifying a set of meeting invitees by means of said address book database;
identifying a meeting location by means of said locations database;
identifying a set of candidate meeting locations by searching the locations database for meeting locations that meet predetermined selection criteria based upon address book information associated with the set of meeting invitees;
specifying a meeting location from the set of candidate meeting locations; and
specifying a meeting time when the invitees and the meeting location are all available by means of said calendar/schedule manager and said reservation function.

20. The method according to claim 19, further comprising the steps of:
providing a resources database responsive to said user interface for identifying one or meeting resources;
providing a resource manager responsive to said user interface for scheduling and reserving meeting resources;
identifying one or more meeting resources by searching the resources database for resource database entries that meet predetermined selection criteria based upon locations database information for the specified meeting location; and
specifying a meeting time when the invitees, the meeting location and the meeting resources are all simultaneously available by means of said calendar/schedule manager, said reservation function and said resource manager.
